(19) United States
(12) Patent Application Publication
(10) Pub. No.: US 2008/0243303 A1
(43) Pub. Date: Oct. 2, 2008

(54) System and methods for collective nanorobotics for electronics applications

(75) Inventor: Neal Solomon, Oakland, CA (US)

Correspondence Address: Neal Solomon, P.O. Box 21297, Oakland, CA, 94620, US

(73) Assignee: Solomon Research LLC, Oakland, CA (US)

(21) Appl. No.: 11/985,083

(22) Filed: Nov. 13, 2007

Related U.S. Application Data
(60) Provisional application No. 60/865,605, filed on Nov. 13, 2006.
(60) Provisional application No. 60/912,133, filed on Apr. 16, 2007.
(60) Provisional application No. 60/941,600, filed on Jun. 1, 2007.
(60) Provisional application No. 60/958,466, filed on Jul. 7, 2007.

(51) Int. Cl. G05B 19/04; G06F 19/00; F42B 33/06

(52) U.S. Cl. 700/245; 86/50; 318/567; 977/903; 901/1

(57) ABSTRACT

The invention describes a system for collective nanorobotics (CNRs) for electronics applications. CNRs are used to selectively activate electronics devices and remote devices and to target objects in sensor networks. A method of delivering CNRs in aerosol form is specified. The CNRs use reaggregation methods to restructure their shapes on-demand for improved material resistance capabilities.

### CROSS-REFERENCES TO RELATED APPLICATIONS

The present application claims the benefit of priority under 35 U.S.C. § 119 from U.S. Provisional Patent Application Ser. No. 60/865,605, filed on Nov. 13, 2006, U.S. Provisional Patent Application Ser. No. 60/912,133, filed Apr. 16, 2007, U.S. Provisional Patent Application Ser. No. 60/941,600, filed Jun. 1, 2007 and U.S. Provisional Patent Application No. 60/958,466, filed Jul. 7, 2007, the disclosures of which are hereby incorporated by reference in their entirety for all purposes.

### FIELD OF THE INVENTION

The present invention pertains to the field of nanotechnology and nanorobotics. The system deals with epigenetic robotics applied to collectives of nanorobots. Specifically, the invention relates to nanoelectromechanical systems (NEMS), microelectromechanical systems (MEMS) and nanomechatronics. The invention also deals with the coordination of collectives of nanorobots and synthetic nanorobotics, including synthetic assemblies of NEMS and nanorobots and synthetic nano-scale and micron-scale machine assembly processes. Applications of these systems and processes are made to nanoelectronics.

### BACKGROUND OF THE INVENTION

To date, four waves, or generations, of nanotechnology have evolved. The first generation was comprised mainly of developments involving chemical composition, such as new nanomaterials. The second generation developed simple tubes and filaments by positioning atoms from the ground up with novel machinery. The third generation developed nanodevices that perform specific functions, such as nanoparticles for the delivery of chemicals. Finally, the fourth wave has developed self-assembling nanoentities by chemical means.

The present invention represents a fifth generation of self-organizing collectives of intelligent nanorobotics. Self-organizing processes are possible at the nano- and micron-level because of the convergence of nanoelectronics developments and nanomechatronics developments.

While the first four generations of nanotechnology have been developed by theoretical scientists and inventors, the fifth generation of nanotechnology has been largely open until now. The present invention fills the gaps in the literature and in the prior art involving nanorobotics.

Early twentieth century theoretical physicists discovered that the simplest atoms were measurable at the nanometer scale of one billionth of a meter. In 1959, in his lecture “Race to the Bottom,” the physicist Richard Feynman proposed a new science and technology to manipulate molecules at the nanoscale. In the 1970s Drexler's pioneering research into nanotechnology molecular-scale machinery provides a foundation for current research. In 1979, researchers at IBM developed scanning tunneling microscopy (STM) with which they manipulated atoms to spell the letters IBM. Also in the 1970s Ratner and his team at Northwestern developed the first nano-scale transistor-like device for nanoelectronics, which was developed into nanotransistors by researchers at the University of California at Berkeley in 1997. Researchers at Rice, Yale and Penn State were able to connect blocks of nanodevices and nanowires, while researchers at Hewlett Packard and UCLA were able to develop a computer memory system based on nano-assembly. Additionally, government researchers at NASA, NIST, DARPA and Naval Research have ongoing nanotechnology development projects, though these are mainly focused on nanoelectronics challenges. Finally, researchers at MIT, Cal Tech, USC, SUNY, Cornell, Maryland, Illinois and other universities in the U.S. have been joined by overseas researchers in developing novel nanotechnologies in order to meet Feynman's challenge.

Nanotech start-up ventures have sprung up to develop nanoscale crystals, to use as biological labels, for use in tagging proteins and nucleic acids (Quantum Dot) and to develop micro-scale arms and grippers by using MEMS to assemble manufacturing devices (Zyvex). Additionally, Nanosys, Nanometrics, Ultatech, Molecular Electronics, Applied Nanotech and Nanorex are ventures that have emerged to develop products in the nanotechnology market space. Until now, however, most of these businesses have focused on inorganic nanomaterials. Though a new generation of materials science has been aided by these earlier generations of nanotechnologies, the real breakthrough lies in identifying methods of developing intelligent systems at the nano-scale.

The two main models for building nanotechnology applications are the ground up method of building entities, on the one hand, and the bottom down method of shrinking photolithography techniques to the nanoscale. Both models present challenges for scientists.

In the case of the bottom up models, several specialized tools have been required. These include (a) atomic force microscopy (AFM), which uses electronics to measure the force exerted on a probe tip as it moves along a surface, (b) scanning tunneling microscopy (STM), which measures electrical current flowing between a scanning tip and a surface, (c) magnetic force microscopy (MFM), which uses a magnetic tip that scans a surface and (d) nanoscale synthesis (NSL), which constructs nanospheres.

In the case of the top down models, several methods and techniques have been developed, including (a) x-ray lithography, (b) ion beam lithography, (c) dip pen nanolithography (DPN), in which a “reservoir of ‘ink’ (atoms/molecules) is stored on top of the scanning probe tip, which is manipulated across the surface, leaving lines and patterns behind” (Ratner, 2003) and (d) micro-imprint lithography (MIL), which emulates a rubber stamp. Lithography techniques generally require the creation of a mask of a main model, which is then reproduced onto a substrate much like a semiconductor is manufactured. It is primarily through lithographic techniques that mass quantities of nanoentities can be created efficiently and cost-effectively.

The main patents obtained in the U.S. in the field of nanotechnology have focused on nanomaterials, MEMS, micro-pumps, micro-sensors, micro-voltaics, lithography, genetic microarray analysis and nano-drug delivery. Examples of these include a meso-microelectromechanical system package (U.S. Pat. No. 6,859,119), micro-opto-electro-mechanical systems (MOEMS) (U.S. Pat. No. 6,580,858), ion beam lithography system (U.S. Pat. No. 6,924,493), carbon nanotube sensors (U.S. Pat. No. 7,013,708) and microfabricated elastomeric valve and pump systems (U.S. Pat. Nos. 6,899,137 and 6,929,030). Finally, patents for a drug targeting system (U.S. Pat. No. 7,025,991) and for a design of artificial genes for use as controls in gene expression analytical system (U.S. Pat. No. 6,943,242), used for a DNA microarray, are applied to biotechnology. For the most part, these patents represent third and fourth generation nanotechnologies.

A new generation of nanotechnologies presents procedures for objects to interact with their environment and solve critical problems on the nano- and micron-scale. This generation of technology involves social intelligence and self-organization capabilities.

Biological analogies help to explain the performance of intelligent or self-organizing nanoentities. In the macro-scale environment, the behaviors of insects provides an important model for understanding how to develop models that emulate social intelligence in which chemical markers (pheromones) are used by individual entities to communicate a social goal. On the micro-scale, microbes and pathogens interoperate with the animal's immune system, in which battles either won or lost determine survival of the host. Other intracellular models show how proteins interact in order to perform a host of functions. At the level of DNA, RNA transcription processes are highly organized methods for developing cellular reproduction. These micromachinery processes and functions occur at the nanoscale and provide useful analogies for nanotechnologies.

In order to draw on these biological system analogies, complexity theory has been developed in recent years. Researchers associated with the Sante Fe Institute have developed a range of theoretical models to merge complexity theory and biologically-inspired processes, including genetic algorithms and collective behavior of economic agents.

Such a new nanotechnology requires distributed computation and communication techniques. It is, moreover, necessary for such a technology to adapt to feedback from its environment. The present invention presents a system in which these operations occur and specifies a range of important applications for electronics, medicine and numerous other areas. The main challenges to this advanced nanotechnology system lie in the discovery of solutions to the problems of limited information, computation, memory, communication, mobility and power.

Challenges

The development of a fifth generation of nanotechnologies faces several challenges. First, the manufacturing of nanoparts is difficult. Second, the assembly of nanoparts into functional devices is a major challenge. Third, the grouping and coordination of collectives of nanodevices is problematic. Fourth, the control and management of nanosystems is complex. Fifth, controlling the interaction of nanorobots in a collective system with its environment is formidable. Since physical properties operate differently at the nano-scale than at the macro-scale, we need to design systems that accommodate these unique physical forces.

The dozens of problems to identify include how to:
Build nanorobots
Connect nanodevices
Develop a nanorobotic power source
Develop nanorobotic computation
Develop specific nanorobotic functionality
Develop nanorobotic communication system(s)
Develop multi-functional nanorobotics
Develop systems in which nanorobots work together
Identify distinctive nanorobotic collective behaviors for specific applications
Activate nanorobotic functionality
Develop nanorobotic computer programming
Develop an external tracking procedure for a nanorobot
Develop an external activation of a nanorobot
Develop a hybrid control system for nanorobots
Use AI for nanorobots
Organize the behavior of nanorobot teams
Reorganize nanorobotic aggregates as teams adapt to environmental feedback
Obtain environmental inputs via sensors
Organize competing teams of nanorobots
Organize cooperating teams of nanorobots
Organize nanorobotic teams to anticipate behaviors
Organize nanorobotic teams to emulate biological processes such as the immune system

Developing Solutions to these Problems

Most prior technological innovations for nano-scale problems have focused on the first generations of nanotechnology and on materials science. The next generation focuses on intelligent systems applied to the nano entities. This fifth generation of innovation combines the development of nano-scale entities with intelligence and the collective behaviors of complex systems.

Few researchers have devised solutions to these complex nano-scale problems. Cavalcanti has developed theoretical notions to develop a model of collective nanorobotics. However, these solutions are not practical and will not work in real situations. For example, there is not enough power of mobility in this model to overcome natural forces. Similarly, according to this theoretical approach, autonomous computation resources of nanorobots are insufficient to perform even the simplest functions, such as targeting. Without computation capacity, AI will not work at this level; without AI there is no possible way to perform real-time environmental reaction and interaction.

Cavalcanti's 2D and 3D simulations are dependent on only several variable assumptions and will not withstand the “chaos” of real environmental interactive processes. In addition, the structure of these nanorobots cannot be built efficiently from the bottom up and still retain critical functionality. Even if these many problems can be solved, individual nanorobots cannot be trusted to behave without error inside cells. In other words, this conceptual generation of medical nanorobots may do more harm than good, particularly if they are not controllable.

The emerging field of epigenetic robotics deals with the relations between a robot and its environment. This field suggests that it is useful to program a robot to learn autonomously by interacting with its environment. However, these models do not apply to collective robotics in which it is necessary to learn from and interact with many more variables in the robots' environment, including other robots. In the case of collectives of nanorobots with resource constraints, the present invention adds volumes to this promising field.

Solomon's research in developing hybrid control systems for collective robotics systems and in developing novel approaches for molecular modeling systems presents pathways to solving these complex problems. These novel research streams are used in the present invention.

Prior systems of collective robotics generally do not address the complexities of nanotechnology. The behavior-based robot system using subsumption methods developed by Brooks at MIT is useful for managing individual robot behavior with limited computation capacity. On the other end of the spectrum, central control robotic systems require substantial computation resources. Hybrid control robotic systems synthesize elements from these two main control processes. Even more advanced robotic control systems involve the integration of a multi-agent software system with a robotic system that is particularly useful in controlling collectives of robots. This advanced collective robotic control system experiences both the benefits and detriments of the behavior-based model and the central control model.

Recent developments in collective robotics have borrowed inspiration from complex biological processes. Complex social behaviors such as flocking, herding and schooling have been studied, with ant algorithms representing the state of the art in computationally emulating and optimizing natural processes. Even more complex natural behaviors at the molecular level are discovered as we learn more about protein interactions. Specifically, the human immune system is a fascinating dynamic interactive network that has evolved over many years. Our challenge is to develop artificial mechanisms to surpass not only ant algorithms, which use the collective behavior of autonomous individuals that use chemical communications methods, but also the interactive workings of the human immunological system.

One of the main methods to develop these complex artificial network models for use in robotic systems is to use evolutionary computation, which emulates biological processes of evolution. Methods such as genetic algorithms or genetic programs emulate the behavior of generations of populations in order to solve complex problems. Similarly, artificial neural network approaches emulate the ability of the human brain to adapt to its environment in order to solve complex problems.

The development of cooperating collectives of robots in a network borrows inspiration from these biological systems. A team of interacting agents takes inspiration from the effective operation of a beehive or an ant colony in which specialist roles and coordination of tasks occur among thousands of agents. These complex network systems use self-organizing models of behavior to aggregate (combine into groups), to reaggregate and to adapt to their environment. However, there are limits to these models because of the constraints of communication, coordination, “computation” and adaptation. The development of artificial systems of collective robotics represents opportunities to surpass these limits. The present system offers numerous insights into optimizing these complex processes.

The Nanorobotic Environment

The nano domain, which is a billionth of a meter, is measured in millionths of a meter. A single oxygen atom is roughly a single nanometer across. A micron is a millionth of a meter. The width of a human hair is about 60,000 nanometers.

The present invention focuses on the synthetic development of objects that are in a middle (meso-nano) sphere somewhat between the atomic size (micro-nano) of simple atoms and the mega-nano domain of micron-sized objects. While it is true that scientists have built, from the ground up, that is, atom by atom, objects such as elegant geodesic nanotubes made of carbon atoms, objects in this domain are too small and too expensive to construct to be useful for an active intelligent system. In order to be useful, a nanorobotic system requires numerous and economical robots dependent on mass production techniques that must generally be considered from the perspective of a top down strategy, that is, by utilization of largely lithographic procedures.

The nanorobotic entities described herein generally consist of objects with dimensions from 100 nm to 1000 nm (1 micron) cubed, but can be smaller than 100 nm or larger than ten microns. This size is relatively large by nanotechnology standards, but is crucial in order to maintain functionality. Keep in mind that a white blood cell is comprised of about 100,000 molecules and fits into this meso-nano domain. The micron-scale space of inter-object interaction may be comprehended by analogy to a warehouse in which nanoscale objects interact. In order to be useful, nanorobots require complex apparatus that includes computation, communications, sensors, actuators, power source and specific functionality, all of which apparatus requires spatial extension. While this domain specification is larger than some of the atomic-scale research in nanotechnology, it is far smaller than most microelectronics.

While the larger meso-nano assemblies described herein possess a specific geometric dimensionality, the size dimensions of the domains in which they operate are also critical to consider. In these cases, each application has a different set of specifications. In the case of the human body, specific cells will have a dimensionality that is substantially larger than the complex molecular-size proteins that are constructed for interoperation within them.

Over time, however, it will be possible to make very small, useful micro-nano scale robots for use in intelligent systems. Thus, we may conceive of several generations of scale for these systems, the first being in the meso-nano domain.

### SUMMARY OF THE INVENTION

There are several electronic and security applications of nanorobotic collective systems. The applications fall into several main categories: sensor networks that transform into active electronic systems; targeting systems that employ nanorobotic collectives and; transformable collectives of nanorobots for intelligent materials.

### ADVANTAGES

Because of the unique properties of collectives of nanorobots (CNRs) that enable them to transform their physical state and position and to organize social intelligence through computation, coordination and communications integration, these technologies provide crucial competitive advantages to those that employ them.

### DESCRIPTION OF THE INVENTION

(1) Distributed Network of Nanosensors for Remote Activation of Electronic System

The present invention is useful to develop a nanosensor network. The intelligent CNR network provides the eyes and ears for external devices, yet remains virtually invisible to detection. Its intermittent communications capability also deters detection. Undetectable nanorobotic capabilities are ideal for reconnaissance missions.

In existing reconnaissance cases, traditional remote sensing apparatuses detect objects and send signals to an external device. With the advantage of CNRs, however, the nanosensors are integrated into the electronic system. A unified sensor-weapon system contains, a sensor network for continuous surveillance but also autonomously detonates an explosive on demand. The advantage of an integrated system is that the CNR sensors feed data sets to the main collective, which then compares relative priorities and seeks to optimize its goals by detonating explosive devices on demand.

The CNR system is integrated into a network with external sensors for full arena awareness. The nanosensor network is also integrated with conventional weapon systems for detonation of large scale explosives.

In another embodiment, the sensor system is constantly mobile. In this case, the network is dynamic and constantly modulating its structure. The CNRs access a solar power unit for auxiliary power. The CNRs have appendages of photovoltaic cells and solar power storage to maintain and sustain power in the field. In one embodiment, CNRs share photovoltaic cells to increase efficiency. The CNRs then migrate to the power source and depart once recharged.

(2) Targeting System for Collective Nanorobotic System

Building effective guidance subsystems are a major challenge in electronic system development. The present system advantageously enables the exploitation of stealthy aspects of CNRs, which are used as beacons to mark a specific spot. The CNRs send a signal to a nearby external facility for tracking. Once the spot is targeted, other weapons zero in to the target and destroy it.

(3) Method for Aerosol Activation of Intelligent Collective Nanorobotic System

Because CNRs change their combined physical structure on demand, the present system is deployable as a gas in order to conserve its spatial delivery options. Once the aerosol is airborne, however, the CNRs autonomously change state to liquid or solid by combining with other CNRs. The nanorobotic collective changes its physical state on demand providing it with chameleon characteristics. The on-demand molecular transformation characteristics of the present intelligent collective nanorobotic system make it a powerful adaptive device.

(4) Collective Nanorobotic System for Intelligent Ubiquitous Munitions with Autonomous Selective Detonation Capability

Because they are very small, because they are able to transform their combined geometric composition, and because they display intelligence, nanorobot collectives are characteristically suited for advanced weaponry. So-called smart dust represents the state of the art of existing military weaponry, yet lacks the true social intelligence of the present invention. One of the benefits of the present system is the development of “transformable” weaponry, that is, weapon systems that transform their physical composition from one state to another. The use of collective nanobiodynotics produces the capability to autonomously transform the structural configuration of the combined collective. This unique feature of the present system produces numerous opportunities to design advanced electronics devices.

The CNRs will blanket a region but only detonate explosives autonomously on demand. That is, once the area is coated with these unique explosives, they will only be activated when they detect a specific object and only detonate in an extent to defeat or disable the enemy or achieve a mission to conserve resources. The CNRs detect and analyze intruder(s) and activate an efficient amount of explosives to disable or destroy the intruder(s). Small amounts of explosives are embedded in the nanorobots, which, when combined with others in the collective and become selectively activated, are effective deterrents. In addition to explosives, the CNRs may be comprised of flammable substances (or other effective chemicals) for greater mission effect.

The CNRs are organized to lie inert for an indefinite period of time and then become activated by an external source such as a laser, a preset temperature or a communication signal. CNRs are virtually undetectable yet extremely powerful in collectives. The collectives of intelligent nanorobots are concentrated in greater numbers to increase effectiveness. The present system ushers in the era of intelligent ubiquitous munitions for post-asymmetric warfare.

(5) Collective Nanorobotic System for Defensive Behaviors Using Reaggregation Methods

Because of their transformative properties, CNRs are used to defend against explosive blasts. Unlike traditional materials science applications of nanotechnology that provide impervious surfaces such as super-polymers for defensive applications, CNRs are able to change their physical structure on demand to create impervious and adaptive shielding. These adaptive shields are selectively activated.

In an analogy to the operation process of a car air bag, once the CNRs detect a threat, they rapidly transform their structure for defensive maneuver by changing to an impervious shell. Once the threat is diminished, the CNRs transform to back a flexible structure.

This modulation process of CNRs by using the evolvable hardware capabilities and self-organization of intelligent systems supplies applied electronic systems with alternating outward expression of a hard shell and flexibility. This CNR application presents novel intelligent materials with strength, flexibility and lightness.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

### DESCRIPTION OF THE DRAWINGS

FIG. 1 is a flow chart showing the organization of a collective of nanorobots in a sensor network as it interacts with an object.

FIG. 2 is a schematic diagram of a nanorobot.

FIG. 3 is a diagram of a sensor network comprised of a collective of nanorobots.

FIG. 4 is a diagram of a collective of nanorobots organized in an area illustrating an object entering its field.

FIG. 5 is a diagram of an object as it enters a field which is clearly marked by a nanorobotic collective.

FIG. 6 is a diagram describing the process of a collective of nanorobots that interact with, and then destroy, an object over several phases.

FIG. 7 is a flow chart showing the process of detecting and destroying an object with a collective of nanorobots.

FIG. 8 is a diagram of a collective of nanorobots that are delivered to the ground in the form of an aerosol.

FIG. 9 is a diagram of the process of transformation of a collective of nanorobots on a fixed wire.

FIG. 10 is a diagram of an object striking a plane reinforced by a reconfigurable collective of nanorobots.

FIG. 11 is a flow chart describing the process of reconfiguration of the physical structure of a collective of nanorobots.

### DETAILED DESCRIPTION OF THE DRAWINGS

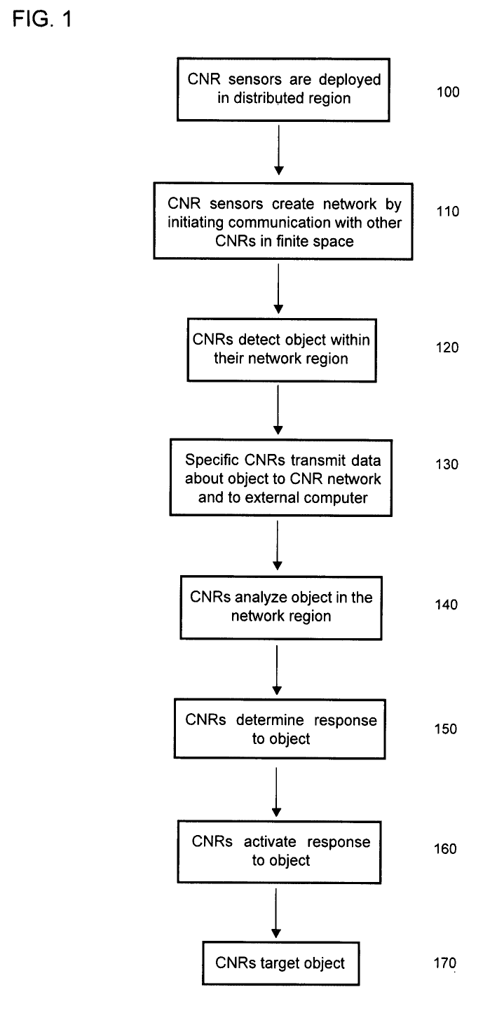

FIG. 1 describes the interaction process of a collective of nanorobots (CNR) with an object by using a sensor network. The same system applies to microrobots as to nanorobots, but the disclosure refers to the nanorobotic embodiment. After the CNR sensors are deployed in a distributed region (100), the CNR sensors create a network by initiating communication with other CNRs in finite space (110). The CNRs detect an object within their network region (120) and specific CNRs transmit data about the object to the CNR network and to an external computer (130). The CNRs analyze an object in the network region (140). Alternatively, the external computer analyzes the object in the network region. The CNRs determine (150) and activate (160) the response to the object (150) and target the object (170).

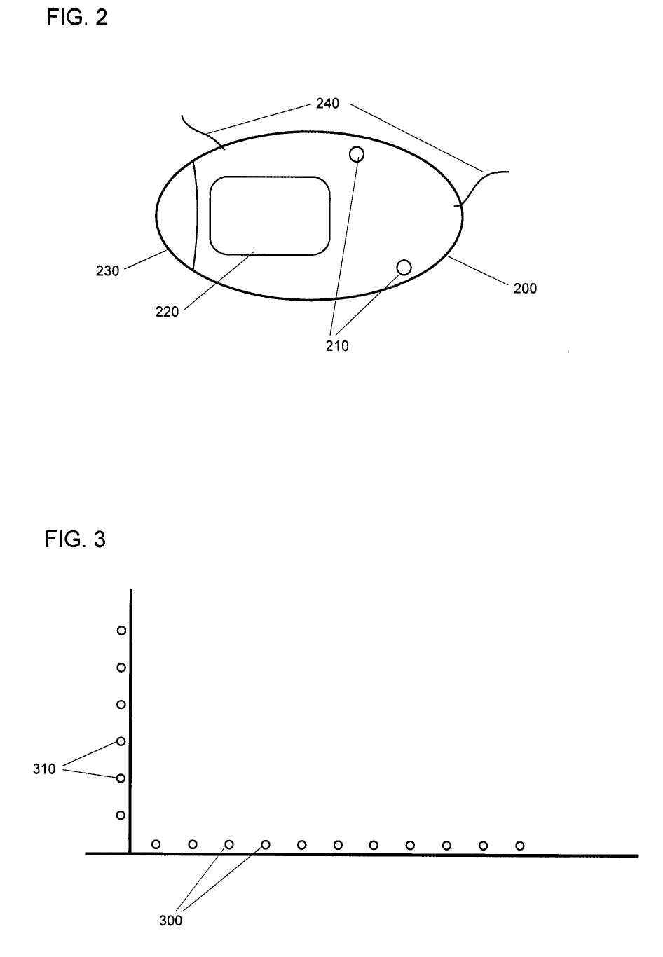

FIG. 2 illustrates a nanorobot. The nanorobot (200) contains an integrated circuit (220) which includes computer memory, an energy source (230) which activates a motor or other functional motility process and sensors (210) and nanofilaments (240) for communications. Though most nanorobot configurations will contain these components, some configurations will include more functionality, such as a specialist utility (i.e., cargo storage, lightweight for speed, specific shape for mobility, enhanced communications, enhanced computation and memory, enhanced sensor functions, and so on).

FIG. 3 shows a CNR sensor network. On the left margin is a pole, wall or wire with vertical alignment (310) which contains a CNR affixed to a vertical façade. On the horizontal alignment is a CNR (300). The two groups are coordinated to provide a three dimensional sensor network which has variable control because the nanorobots are capable of moving positions.

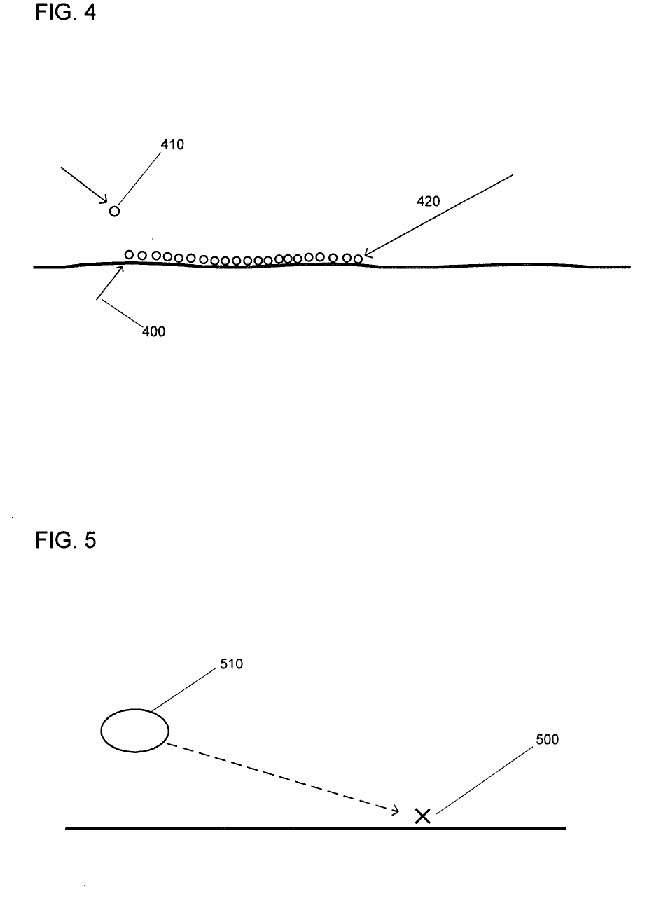

FIG. 4 shows a nanorobotic collective on the ground (400) with an object (410) moving in trajectory to strike a region of the nanorobotic field. The nanorobots at the arrow (420) are activated remotely by a laser or communication signal. FIG. 5 shows how a CNR (500), which is largely undetectable, is used to mark a target. An explosive (510) is used to target the CNR, which behaves like a beacon.

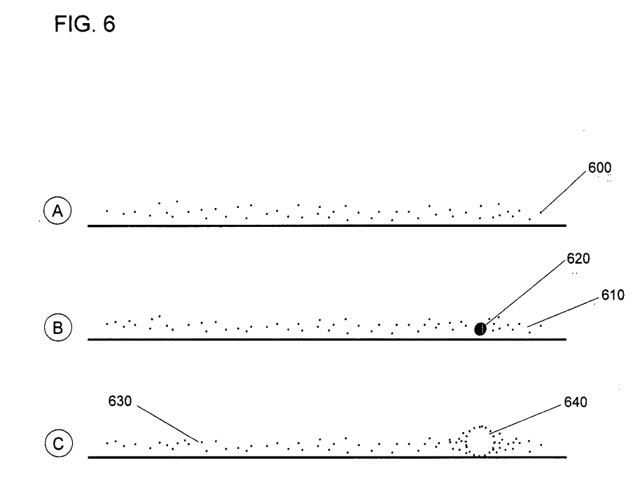

FIG. 6 shows the process of using CNRs to selectively target and attack an object. In phase A, the CNR is laid out on the ground in a specific region (600). In phase B, an object (620) enters the CNR field (610). The CNR identifies and analyzes the object. Finally, in phase C, the CNR (630) selectively activates an explosive to precisely remove the object (640). The CNR then redistributes around the space of the destroyed CNRs. This process is useful to autonomously and efficiently destroy objects in a field as the objects are identified.

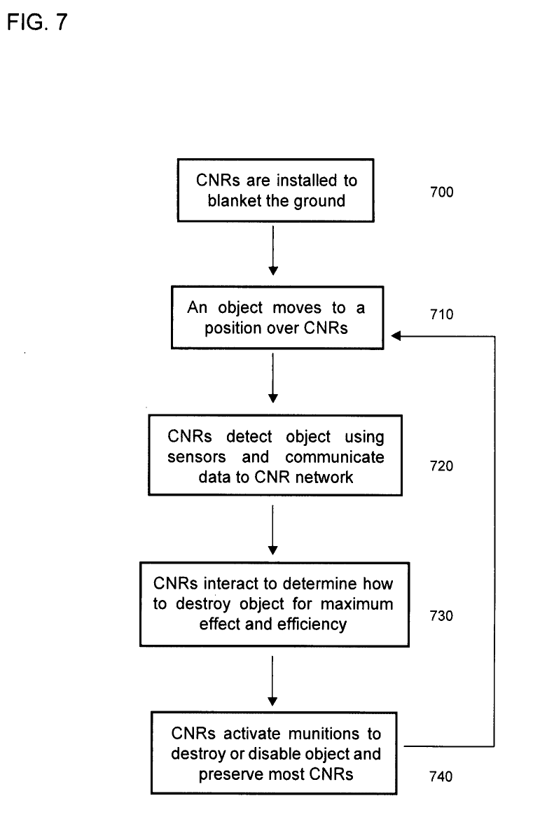

FIG. 7 is a flow chart showing how CNRs operate to efficiently destroy an object in its field. After the CNRs are installed to blanket the ground (700), an object moves to a position over the CNRs (710). The CNRs detect the object using sensors and communicate data to the CNR network (720). The CNRs then interact to determine how to destroy the object for maximum effect and efficiency (730). The CNRs activate munitions to destroy or disable the object and preserve most of the CNRs (740).

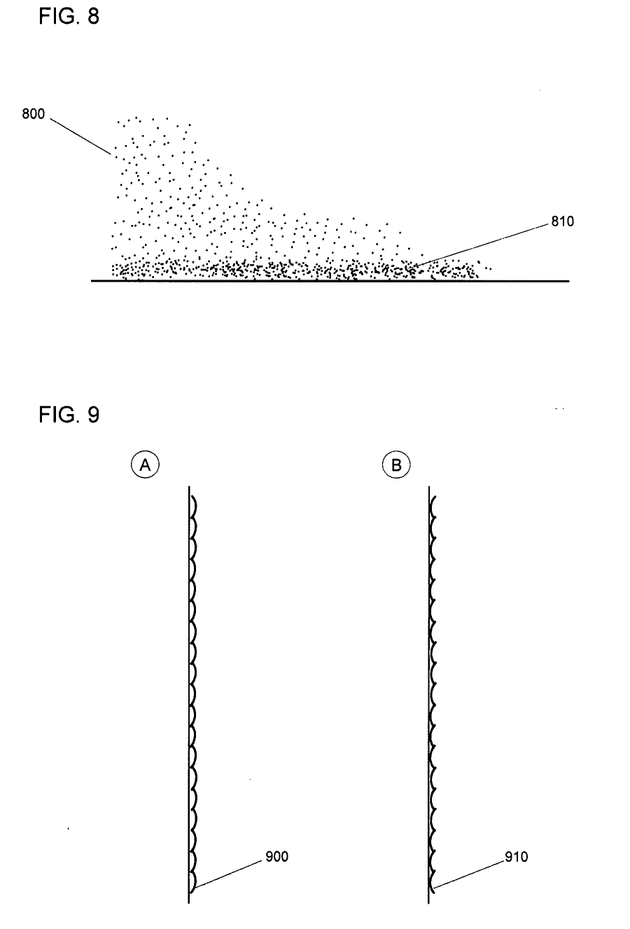

FIG. 8 shows the distribution of CNRs delivered as an aerosol (800). Once the CNRs fall to the ground by using the force of gravity, they assemble in a distributed region (810). The CNRs have higher concentrations on the ground layer as they aggregate into a solid structure. The CNRs may then be used as a sensor network or as a selective explosive system. The CNRs then change their structure by using reaggregation methods.

FIG. 9 shows the CNRs on a wire transforming from position 900 in phase A to position 910 in phase B. This activation process (a) is selective, (b) affects only a specific cluster of CNRs at one time and (c) occurs once the CNRs initiate a response to a stimulus.

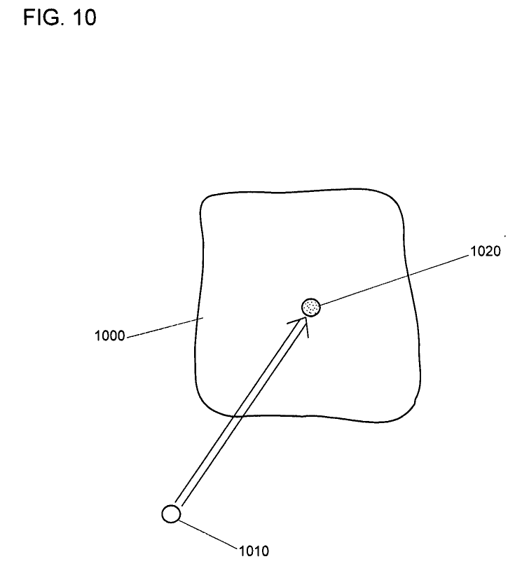

FIG. 10 shows a plate that is coated with transformable CNRs. When an object (1010) strikes a place (1020) on the plate (1000), they are activated to transform to a hardened physical state in order to repel the object. The activation process works like an automobile airbag in which a sensor stimulates the active state. The plate is installed in body armor. The advantage of the system is that the CNRs temporarily transform their structure on demand to a hardened state, but are not be in a perpetual state of activation that would be uncomfortable for the user.

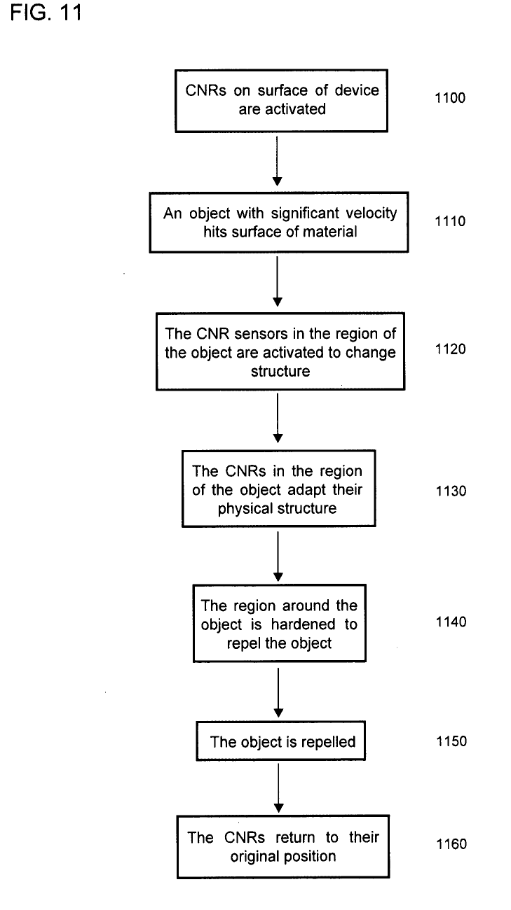

The process of activating transformable CNRs on a surface is described in FIG. 11. After the CNRs on the surface of the device are activated (1100) to transform their physical state to a hardened structure, an object with significant velocity hits the surface of the material (1110). The CNR sensors in the region of the object are activated to change the structure (1120). The CNRs in the region of the object adapt their physical structure (1130) and the region around the object is hardened to repel the object (1140). The object is then repelled (1150). The CNRs then return to their original position (1160).

What is claimed is:

1. A system for managing automated collective nanorobots (CNRs),
comprising:
A plurality of nanorobots, each nanorobot including program code configured to communicate and exchange information with other nanorobots;
Wherein the nanorobots in the collective are configured to track each other;
Wherein the nanorobots are mobile;
Wherein the nanorobot sensors feed data sets to the main collective;
Wherein the CNRs compare relative priorities and seek to optimize its goals by activating electronic devices on demand;
Wherein the electronic devices include munitions; and
Wherein the CNRs access a solar energy source for continuous activity.

2. The system of claim 1, wherein:
The CNRs are deployed to mark a specific location; and
The specific marked location is targeted for destruction by weapons.

3. A system for managing automated collective nanorobots (CNRs), comprising:
A plurality of nanorobots, each nanorobot including program code configured to communicate and exchange information with other nanorobots;
Wherein CNRs are used for collective nanobiodynotics to autonomously transform the structural configuration of the combined collective to promote concealment;
Wherein a system of intelligent ubiquitous munitions is deployed by engaging the CNRs to blanket a region but detonate explosives autonomously on demand when a specific programmed threshold is satisfied;
Wherein the amount of munitions deployed is limited to the extent of the threat in the specific region;
Wherein the CNRs are organized to lie inert before they are activated by an external source; and
Wherein the external source of activation is a laser, a preset temperature or a communication signal.

4. A system for managing automated collective nanorobots (CNRs),
comprising:
A plurality of nanorobots, each nanorobot including program code configured to communicate and exchange information with other nanorobots;
Wherein CNRs are used on the surface of polymers configured in sheets;
Wherein the CNRs change their physical structure on demand to create impervious and adaptive shielding;
Wherein the CNRs are activated to change their physical structure by responding to a signal that signifies a threat; and
Wherein the CNRs reaggregate their structure from a soft state to a solid state when activated.
